(19) United States
(12) Patent Application Publication
(10) Pub. No.: US 2008/0272244 A1
(43) Pub. Date: Nov. 6, 2008

(54) Hybrid Aircraft

(75) Inventors: Mads Bjornenak, Mandal (NO); Vegard Evjen Hovstein, Leksvik (NO); Ragnvald Otterlei, Kongsberg (NO)

Correspondence Address: BROOKS KUSHMAN P.C., 1000 TOWN CENTER, TWENTY-SECOND FLOOR, SOUTHFIELD, MI, 48075, US

(73) Assignee: SIMICON AS, Kongsberg (NO)

(21) Appl. No.: 11/571,442

(22) PCT Filed: Jun. 24, 2005
(86) PCT No.: PCT/NO2005/000228

§ 371 Date: Jan. 28, 2007

(30) Foreign Application Priority Data
Jul. 2, 2004 (NO) 2004 2823

(51) Int. Cl. B64C 27/30

(52) U.S. Cl. 244/7 R

(57) ABSTRACT

A hybrid aircraft (1) comprising an elongated fuselage (2), a rotor (3) having rotor blades (7) and a wing part (4) projecting from each side of the fuselage (2), is disclosed. Each wing part (4) is arranged rotatable about its longitudinal axis to the fuselage (2).

The present invention relates to a hybrid aircraft comprising a fuselage, a rotor and a wing.

The background for the present invention is the desire to develop a totally new concept for a hybrid aircraft. As far as possible, it shall constitute an optimal compromise between a helicopter and an aircraft having fixed wing. The concept is primarily intended for unattended smaller aircrafts like reconnaissance planes, without this being considered as any limitation. Aircrafts of this type are shown in WO 01/56879 A1 and WO 02/096752 A1.

Examples of the prior art regarding helicopters having retractable rotor wings are disclosed in U.S. Pat. No. 6,062,508 and U.S. Pat. No. 5,240,204. Further examples of the prior art are disclosed in U.S. Pat. No. 1,418,248 and U.S. Pat. No. 4,913,376.

One object with the present invention has been to provide a hybrid aircraft that can regulate smooth and infinitely variable in the transition from rotor mode, i.e. helicopter drive mode, to fixed wing mode, i.e. airplane drive mode.

The concept does improve controlled transfer, or transition, in several aspects:
1) Total cyclic and collective control of the rotor system during the entire transition phase—this means very good control with “roll”, “pitch” and vertical motions.
2) “Thrust-vectoring” in the tail section provides large possibility for control of “pitch” and “yaw” motions.
3) Main wings having high side ratio and operable dynamic control surfaces which are exposed to “rotor-downwash” in the entire transition phase, provides extremely good control of “roll” and “yaw” motions.

The technology will provide a controlled and safe transition from rotor power mode to fixed wing mode and back again. This will open up for a number of uses:
1) Effective helicopter properties and simultaneously have: high velocity properties, range and action time as a fixed wing aircraft.
2) Effective fixed wing properties and simultaneously have: good “hovering” properties, slow flying properties as a conventional helicopter and possibilities for vertical take off and landing.

This is achieved according to the present invention in that a hybrid aircraft of the introductory said kind is provided, which is distinguished in that the wing is tiltably arranged to the fuselage.

Preferably the rotor includes an enclosure that receives respective retractable and extendible rotor blades.

In one embodiment the rotor design can be of the type that is disclosed and described in Norwegian Patent Application no. 2003 5350. The rotor construction is here combined with a wing in which the active part of the rotor blades is nearly doubled compared with what has been suggested earlier. This implies that the active part of the rotor blade not only corresponds with one radius length of the fixed housing or wing, but actually close to a diameter length. The purpose of having retractable rotor blades in an aircraft of this nature is to reduce the air drag at high velocities. The larger the ratio is between the rotor area and the wing area the rotor shall retract into, the better it is—i.e. lower air drag.

Preferably the respective rotor blades are tiltable about their longitudinal axis relative to the rotor housing.

In preferable embodiments the aircraft includes a tail rotor. The tail rotor preferably includes a propeller which in turn is surrounded by a duct. Moreover the duct may include one or more control fins.

Suitably the wing of the hybrid air craft includes respective control surfaces. Each wing half can optionally include several independent operable control surfaces.

Other and further objects, features and advantages will appear from the following description of one preferred embodiment of the invention, which is given for the purpose of description and given in context with the appended drawings where:

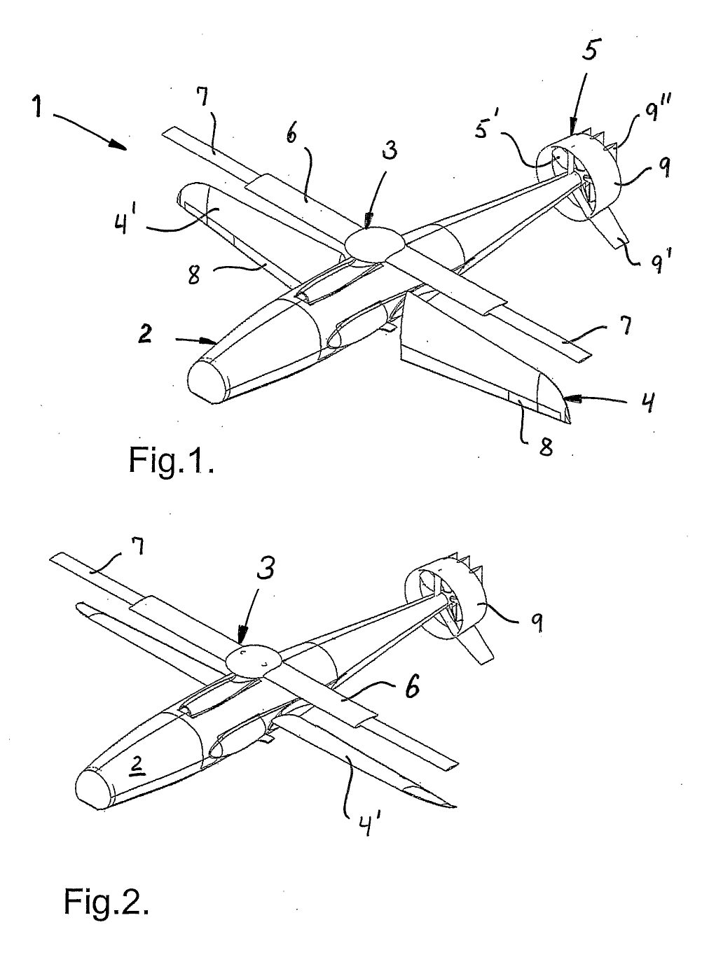

FIG. 1 shows in schematic perspective view an aircraft according to the invention during vertical lift,

FIG. 2 shows schematically the aircraft according to FIG. 1 during accelerated motion forward at approximately 50 km/h,

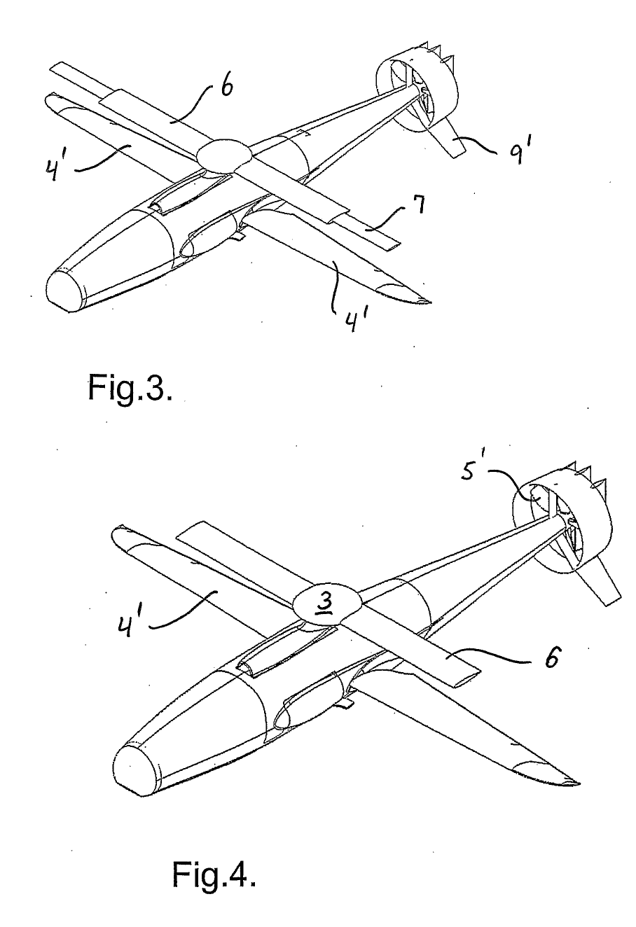

FIG. 3 shows schematically the aircraft according to FIG. 1 during flight forward at approximately 120 km/h,

FIG. 4 shows schematically the aircraft according to FIG. 1 during flight forward at approximately 170 km/h,

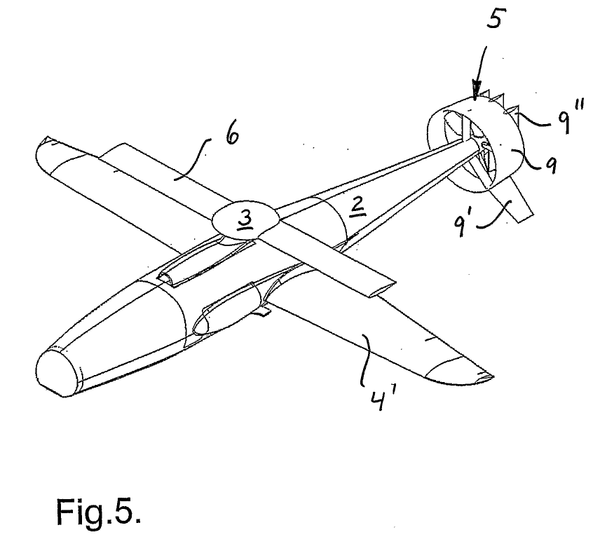

FIG. 5 shows schematically the aircraft according to FIG. 1 during flight forward at approximately 200 km/h.

With reference to the FIGS. 1-5 a hybrid aircraft 1 will now be described in closer detail during different maneuvering phases. The aircraft 1 comprises a fuselage 2, a main rotor 3 and a wing 4. The main rotor 3 includes a rotor housing 6 that receives a rotor mechanism (not shown) having at least two rotor blades 7 that can be completely retracted into the rotor housing 6. In particular, it is to be noted that the rotor housing 6 is rotatable together with the rotor blades 7. The rotor blades 7 are in turn somewhat tiltable about their longitudinal axes relative to the rotor housing 6.

In addition the aircraft has a tail rotor 5 which provides forward thrust for propulsion. The tail rotor 5 comprises a propeller 5′ that is rotatable arranged within a surrounding duct 9 which in turn has projecting control fins 9′ and stabilizing fins 9″.

FIG. 1 shows the air craft 1 during vertical lift and without substantial horizontal forward propulsion. The vertical lift is performed by the main rotor 3 where respective rotor blades 7 are completely extended as shown in the figure. Each wing half 4′ is tiltable supported to the fuselage 2 and is shown in FIG. 1 turned approximately 90° relative to its position during normal flight. Each wing half 4′ has respective control surfaces 8 that can be remote controlled to perform angular deflection relative to the wing half 4′ for maneuvering of the aircraft at different phases and situations. During vertical lift the control surfaces 8 are pointing downward and the wing halves 4′ provide a yaw moment in order to counteract the moment generated by the main rotor system. It is to be added that the tail rotor 5 provides further counteracting yaw moment.

The aircraft 1 needs to be controlled within 6 degrees of freedom by means of:
1) “Vertical lift”: Main rotor 3 collective “pitch”
2) “Roll-control”: Main rotor 3 cyclic “pitch”
3) “Pitch-control”: Main rotor 3 cyclic “Pitch”+“thrust vectoring tail section”
4) “Yaw-control”: “Tilted main-wings w/control surfaces+“thrust vectoring tail section”
5) “Forward thrust”: Main rotor 3 “cyclic pitch”+“tail propeller”
6) “Side-force”: Main rotor 3 “cyclic pitch”

FIG. 2 shows the aircraft 1 during early acceleration forward, like 50 km/h. The aircraft 1 is accelerated forward by the duct surrounded propeller 5′ arranged at the rear end of the fuselage 2. The main rotor 3 provides vertical lift, and has the main control on “pitch” and “roll” motions. The tiltable wing halves 4′ are gradually turned up toward flight position in order to initiate to create a small lift component in the air stream from the main rotor 3 and the free air stream due to the forward velocity.

The 6 degrees of freedom of the aircraft 1 are controlled by means of:
1) “Vertical lift”: Main rotor 3 collective “pitch”+small contribution from the main wing
2) “Roll-control”: Main rotor 3 cyclic “pitch”
3) “Pitch-control”: Main rotor 3 cyclic “pitch”+“thrust vectoring tail section”
4) “Yaw-control”: “Tilted main-wings w/control surfaces+“thrust vectoring tail section”
5) “Forward thrust”: “Tail propeller”+main rotor 3 “cyclic pitch”
6) “Side-force”:

FIG. 3 shows the aircraft 1 during further acceleration forward, such as at 120 km/h. The aircraft 1 is still accelerated forward by the duct surrounded propeller 5′. The main rotor 3 now provides less vertical lift and the rotor blades 7 are halfway pulled into the rotor housing 6. The tiltable wing halves 4′ are further turned up toward flight position and provide approximately half of the required lifting force.

The 6 degrees of freedom of the aircraft 1 are controlled by means of:
1) “Vertical lift”: The main wing with high lift means+main rotor 3 collective “pitch”
2) “Roll-control”: “Ailerons+main rotor 3 cyclic “pitch”
3) “Pitch-control”: Elevator+“thrust vectoring tail section”+main rotor 3 cyclic “pitch”
4) “Yaw-control”: “Vertical tail section/thrust vectoring”+“Tilted main-wings w/control surfaces”
5) “Forward thrust”: “Tail propeller”
6) “Side-force”:

FIG. 4 shows the aircraft 1 during further acceleration forward, such as at 170 km/h. The aircraft 1 is still accelerated forward by the duct surrounded propeller 5′. The main rotor 3 now provides minimum vertical lift and the rotor blades 7 are completely retracted into the rotor housing 6. The rotor housing 6 is gradually retarded and stopped. The tiltable wing halves 4′ are further turned up toward flight position and now provide most of the required lifting force.

The 6 degrees of freedom of the aircraft 1 are controlled by means of:
1) “Vertical lift”: The main wing with high lift means+main rotor 3 collective “pitch”
2) “Roll-control”: “Ailerons”
3) “Pitch-control”: Elevator+“thrust vectoring tail section”
4) “Yaw-control”: “Vertical tail section/thrust vectoring”
5) “Forward thrust”: “Tail propeller”
6) “Side-force”:

FIG. 5 shows the aircraft 1 during steady, smooth flight, such as at 200 km/h. The aircraft 1 is propelled forward by the duct surrounded propeller 5′ and in principle flies in the same way as a conventional aircraft having fixed wing. The rotor housing 6 is stopped in a position transversal to the fuselage 2 and the rotor blades 7 are still fully retracted into the rotor housing 6. The tiltable wing halves 4′ are completely turned up into flight position and now provide all required lifting force. During flight forward the rotor housing 6 is trimmed so that minimum air drag is produced. The rotor housing 6 will not contribute to the lift during flight.

The 6 degrees of freedom of the aircraft 1 are controlled by means of:
1) “Vertical lift”: The main wing
2) “Roll-control”: “Ailerons”
3) “Pitch-control”: Elevator+“thrust vectoring tail section”
4) “Yaw-control”: “Vertical tail section/thrust vectoring”
5) “Forward thrust”: “Tail propeller”
6) “Side-force”:

1. A hybrid aircraft comprising an elongated fuselage, a rotor having rotor blades and a wing part projecting from each side of the fuselage, wherein each wing part is tiltable arranged about its longitudinal axis to the fuselage.

2. A hybrid aircraft according to claim 1, wherein the rotor comprises a rotor housing occupying respective retractable and extendible rotor blades.

3. A hybrid aircraft according to claim 2, wherein the respective rotor blades are tiltable relative to the rotor housing about their longitudinal axis.

4. A hybrid aircraft according to claim 1, wherein the aircraft comprises a tail rotor.

5. A hybrid aircraft according to claim 4, wherein the tail rotor comprises a propeller surrounded by a duct.

6. A hybrid aircraft according to claim 5, wherein the duct includes one or more control fins.

7. A hybrid aircraft according to claim 1, wherein the wing comprises respective control surfaces.

8. A hybrid aircraft according to claim 1, wherein each wing half comprises several independent operable control surfaces.
